(19) United States
(12) Patent Application Publication
(10) Pub. No.: US 2025/0124064 A1
(43) Pub. Date: Apr. 17, 2025

(54) Method And System For Knowledge-Base Interactions

(71) Applicant: Text S.A., Wroclaw (PL)

(72) Inventor: Grzegorz Pasieka, Ptakowice (PL)

(73) Assignee: Text S.A., Wroclaw (PL)

(21) Appl. No.: 18/916,908

(22) Filed: Oct. 16, 2024

Related U.S. Application Data
(60) Provisional application No. 63/544,243, filed on Oct. 16, 2023.

(51) Int. Cl. G06F 16/332; G06F 16/33

(52) U.S. Cl. CPC G06F 16/3329; G06F 16/3344

(57) ABSTRACT

The present disclosure is directed to a method and system for knowledge-based interaction, facilitating efficient and accurate responses to user queries. The system integrates advanced natural language processing, machine learning, and real-time expert input to generate contextually relevant answers. It dynamically adjusts response confidence based on query complexity, ensuring reliable communication. Agents can contribute their expertise via a mobile interface, enriching the system's knowledge base and enhancing its learning capabilities. The system is designed for scalability and integrates seamlessly with other platforms through robust API structures.

### CROSS-REFERENCE TO RELATED APPLICATIONS

This application claims priority to U.S. Provisional Patent Application No. 63/544,243, filed 16 Oct. 2023, the entirety of which is incorporated herein by reference.

### BACKGROUND OF THE INVENTION

The present invention relates to systems and methods for facilitating knowledge-based interactions, particularly within contexts requiring accurate and efficient responses to user queries. In various industries, there is an escalating demand for automated systems capable of handling a wide array of user inquiries, delivering not just pre-programmed answers but also dynamically generated responses based on evolving data sets.

Traditional knowledge-based systems rely heavily on static databases, which often limit their ability to adapt to diverse and complex questions. These systems typically use straightforward keyword matching or predefined response templates, which can result in inadequate or irrelevant answers, particularly in situations where context or nuance is critical. Additionally, these systems often lack the capability to engage human experts dynamically when automated responses fall short, leading to a poor user experience.

The present invention addresses these limitations by introducing a sophisticated method and system for knowledge-based interaction that incorporates advanced natural language processing (NLP), machine learning, and real-time expert engagement. This approach not only enhances the accuracy and relevance of automated responses but also provides a mechanism for continuous learning and improvement based on human feedback.

### BRIEF SUMMARY OF THE INVENTION

The present invention provides a method and system designed to enhance knowledge-based interactions through the integration of automated processing techniques and real-time expert input. The system enables agents to train models using a variety of data processing techniques, ensuring responses are accurately created to user queries.

Users initiate interactions through various communication channels, including text interfaces, voice commands, and emerging interactive methods. Upon receiving a user query, the system performs a multi-layered analysis using techniques such as keyword matching, NLP, and pattern recognition. The system's deep semantic understanding allows it to interpret nuances and context within user queries, far surpassing the capabilities of traditional information retrieval systems.

The system generates a confidence score for each potential response, reflecting the system's certainty in its accuracy. This score can be dynamically adjusted based on the complexity of the query, ensuring users receive the most appropriate response. If the system lacks sufficient confidence or information, it triggers a notification to expert agents via a mobile application, allowing them to provide real-time input or even engage directly with the user if necessary.

Agents can contribute their expertise through a mobile interface, where they can provide factual information, context, and multimedia content to enrich the system's knowledge base. This agent input is subject to peer review and can be integrated into the system's learning algorithms, ensuring continuous improvement and adaptability.

The system is designed for seamless integration with other platforms through API structures, utilizing both virtual and physical databases to optimize processing power and data management.

### BRIEF DESCRIPTION OF THE SEVERAL VIEWS OF THE DRAWINGS

Further advantages features and details of the various embodiments of this disclosure will become apparent from the ensuing description of a preferred exemplary embodiment or embodiments and further with the aid of the drawings. The features and combinations of features recited below in the description, as well as the features and feature combination shown after that in the drawing description or in the drawings alone, may be used not only in the particular combination recited but also in other combinations on their own without departing from the scope of the disclosure.

In the following, advantageous examples of the disclosure are set out with reference to the accompanying drawings, wherein:

FIG. 1 depicts the overall system architecture, showing the interaction between the user, system, and agent;

FIG. 2 depicts the process flow for analyzing a user query and generating a response;

FIG. 3 depicts the agent interface and the process for contributing expert knowledge to the system;

FIG. 4 depicts the agent interface and the process for contributing expert knowledge to the system with the use of mobile notification for the agent;

FIG. 5 depicts the agent interface and the process for contributing expert knowledge to the system with the use of a web application for the agent;

FIG. 6 depicts the process flow for analyzing a user query and generating a response when the response is previewed and/or edited by the agent; and

FIG. 7 depicts the agent interface and the process for contributing expert knowledge to the system with the database structure shown.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” should be understood as including only one of A, only one of B, only one of C, or any combination of A, B, and C. In the figures, the same or functionally identical elements have been provided with the same reference signs.

The invention, with general reference to the figures, is referred to herein as the “Knowledge-Based Interaction System,” and leverages a combination of data processing, machine learning, and real-time human input to create a dynamic and responsive knowledge base. The system is designed to handle a wide range of queries across various fields, providing accurate and contextually appropriate responses.

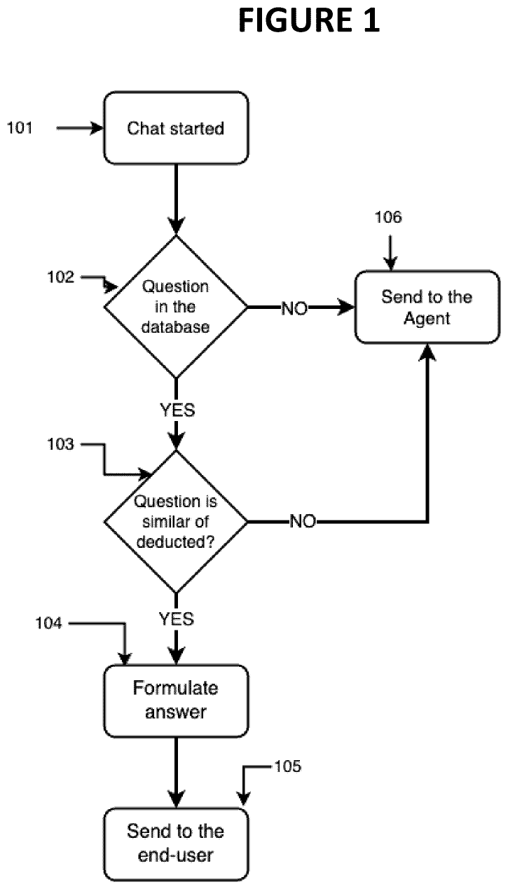

A first embodiment of the presently described invention is set out in FIG. 1. As depicted, in the first embodiment of the invention, the process begins with the chat user entering an instant communication channel (101). Upon the user submitting a query, such as “Where can I find running shoes that are good for trail running?”, the system analyzes the input (102). If the system cannot find a match for any part of the query using existing patterns, elements, or data stored in the database, the query is forwarded to an agent (106). The agent, in this context, is a person managing the instant communication channel on behalf of the vendor, such as the owner of the online store. However, if a response can be generated based on machine learning techniques and prior knowledge (103), the system formulates the answer (104) and delivers it to the end user who submitted the query (105).

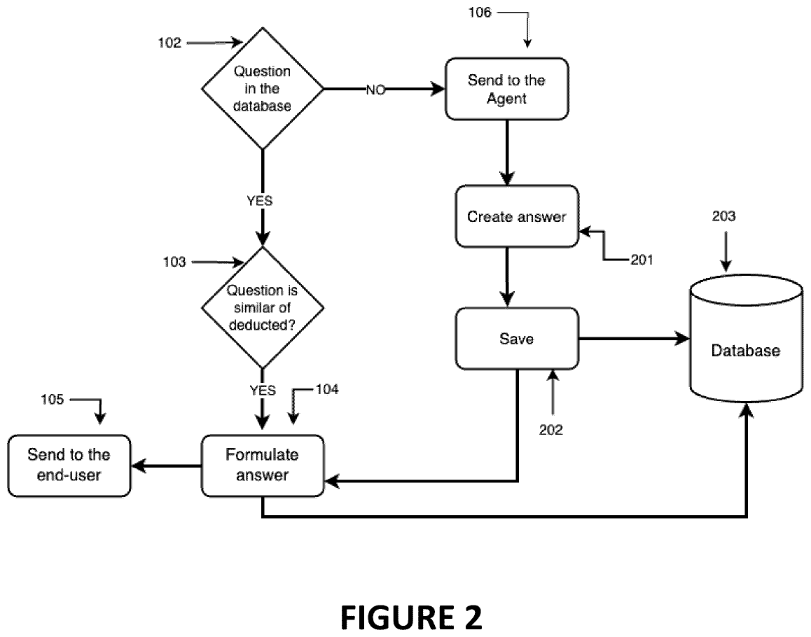

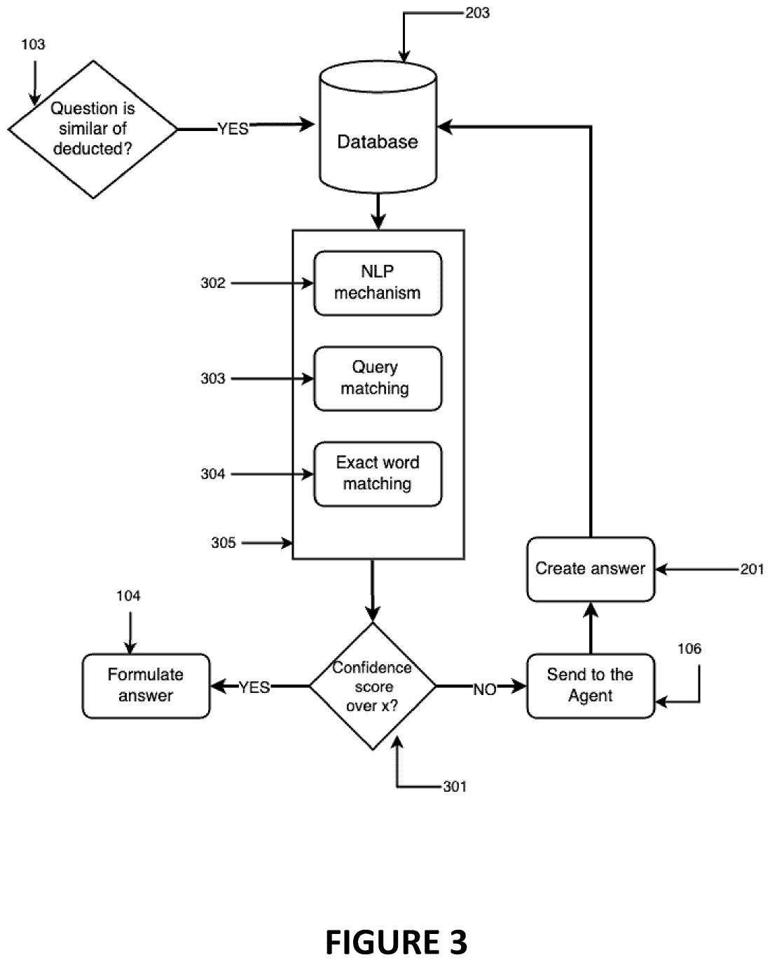

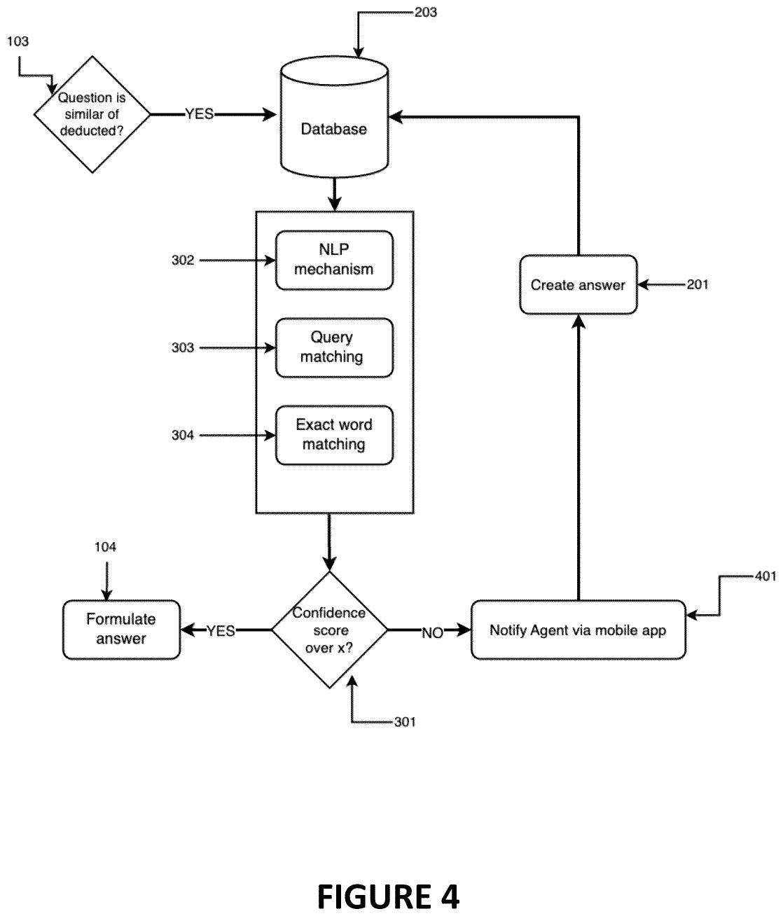

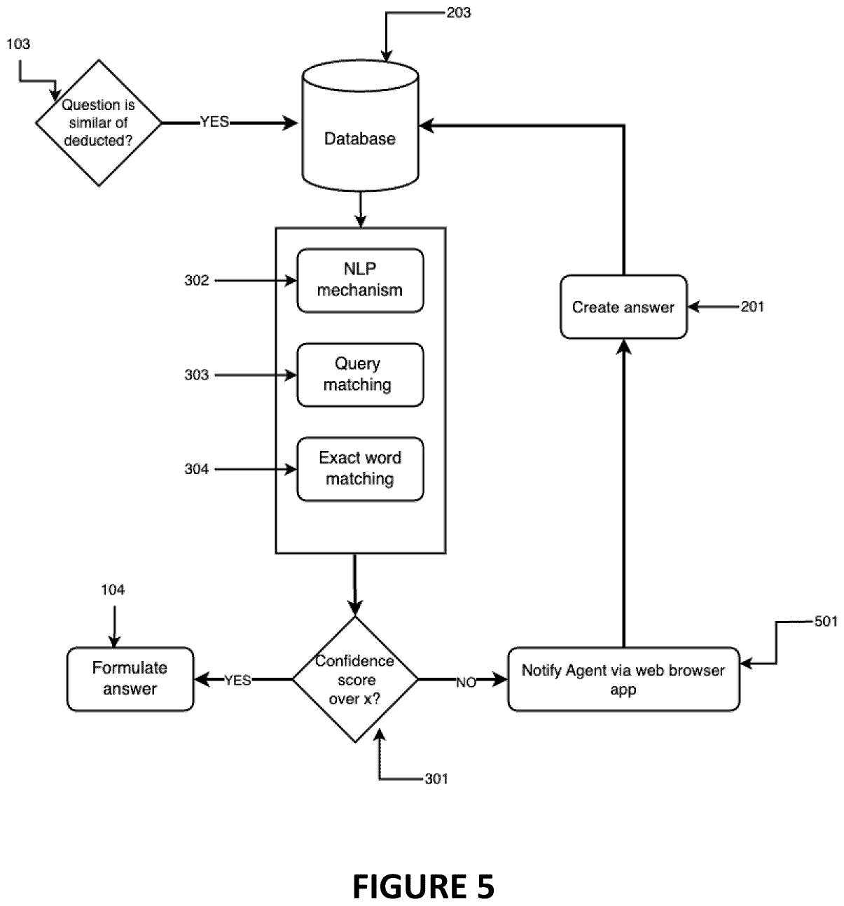

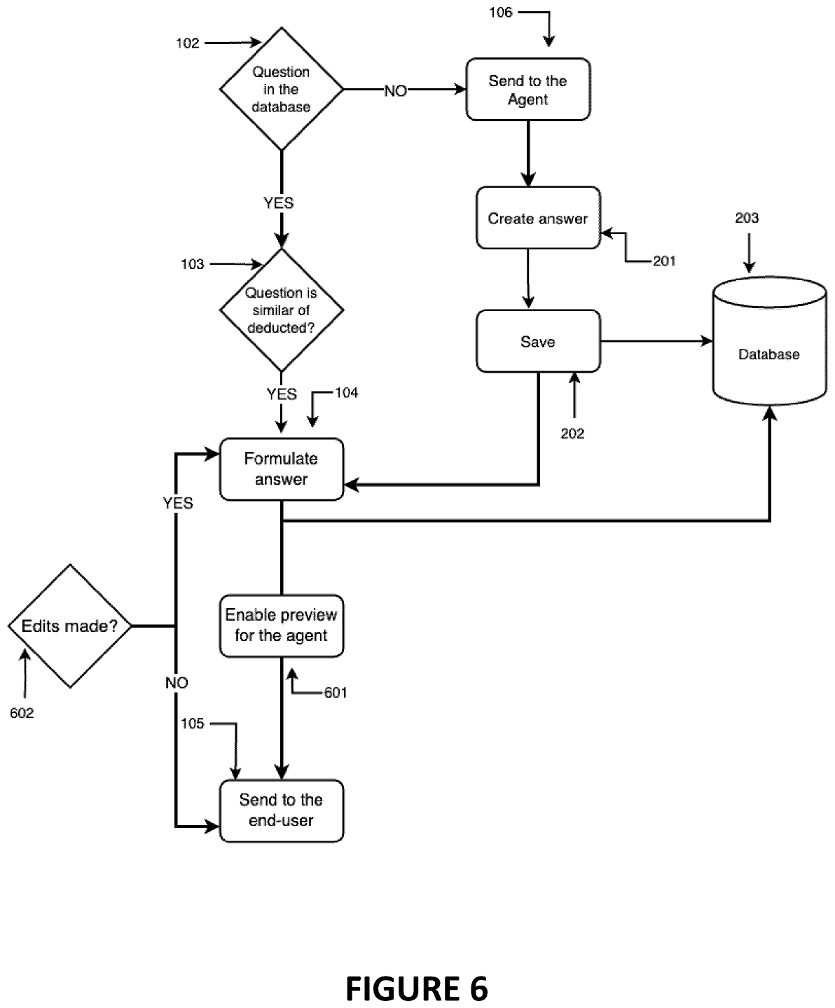

Another embodiment of the presently described invention is set out in FIG. 2. As depicted, the another embodiment of the invention involves the handling of data processed by the system, which is collected through the user interface and subsequently transferred either to the agent or directly to the end user, and stored in the database. Once an answer is generated (202), the newly created response, along with any modifications made by the agent, is saved in the database (203). This functionality is facilitated by the following elements of the embodiment:
User Interface (UI): Users interact with the system via a UI, which can include text-based chat widgets, voice command interfaces, or other communication platforms. The UI is designed to be intuitive, allowing users to input queries in natural language.
Processing Engine: This core component processes the user's input using NLP, keyword matching, and pattern recognition. As depicted in FIG. 3, the processing engine (305) also includes a confidence scoring module (301), which assesses the likelihood that a generated response is accurate and relevant.
Knowledge Repository: The knowledge repository is a database (203) that stores information, including pre-existing knowledge, agent-contributed data, and system-learned insights. It is structured to allow quick retrieval of relevant data based on the user's query.
Agent Interface: The system, as depicted in FIG. 4, includes a mobile (401) and, as depicted in FIG. 5, web-based interface for agents (501), enabling them to contribute expert knowledge (201), monitor ongoing conversations (see FIG. 6, 601), and intervene in real time when necessary. If the intervention results in any changes (602), then the system adjusts the formulated response (104) and further adjusts the data set that is further used for the next answer-generating process (203).
Machine Learning Module: The system continuously learns from interactions (302, 303, 304). The machine learning module receives feedback with regard to successful interactions and adjusts its algorithms to improve future responses. Such a process is further considered based on the potential adjustments from the agent (602) and its results (105).
API Integration: The system is designed to integrate with other platforms through APIs, enabling data exchange and system interoperability.

As the further embodiment of the invention, the process begins when a user submits a query through the system's UI (102). For the purposes of this application, a query should be understood as any form of question or request, such as “Where can I find the help section?”, “How can I adjust my order?”, “I want to receive a refund,” or more complex, context-specific inquiries. This query is immediately analyzed by the processing engine, which employs a combination of query matching (303), NLP (302), and pattern recognition (304) to interpret the question. The engine processes the query to determine the most relevant response from the knowledge repository saved in the database (203), wherein the database can include a cloud database, a physical machine with virtual machines set up, or a combination of any of those two to provide further efficiency. The embodiment of the invention categorizes possible responses based on the confidence score (301), which is created as the outcome of machine learning processing activities. Confidence score helps to set a minimum accuracy model that shall further help to redirect to the agent only conversations that require attention (106) and automatically deliver responses when the confidence score is high (104).

Further, the embodiment of the invention uses a plurality of forms to notify the agent about a need to provide feedback on the generated answer based on the confidence score (301). One such form is notification via mobile application (401), and the other possibility includes notification via web browser app (501). Feedback provided by the agent is possible by the formulated message preview (601) that further includes all context that is relevant to the formulated answer as full message from the end-user, time, prior communication with the end user etc. When the feedback is collected (601), the system sends a response to the end user and further enriches the dataset (203).

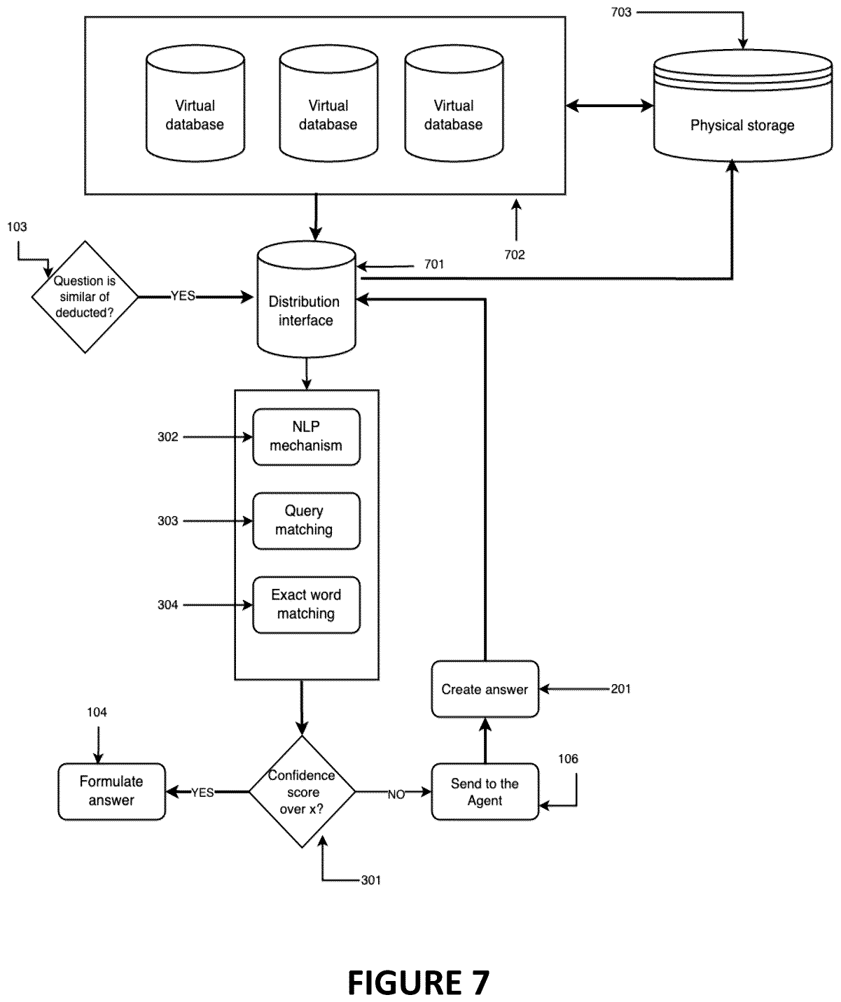

A still further embodiment is depicted in FIG. 7, wherein the present disclosure primarily consists of three infrastructural elements with regard to the knowledge base interactions and storage: a. local storage configured within the virtual infrastructure (702), b. a data storage center hosted on a server that provides a physical repository for data (703), and c. distribution interface responsible for the data distribution and saving model (701). Processed data is further displayed via a front-end interface that allows the first user (agent) to select data for display on the second user's screen (105). These components are designed to communicate over a computer network and operate within instant communication channels such as chat. The embodiments are compatible with any device that has Internet access and can display a web page or application with an integrated chat feature.

Upon receiving the user's input, the embodiment of the invention starts with the analysis of the question asked via input (102). This analysis includes keyword matching (304), Natural Language Processing (302), and different forms of pattern matching (303) including speech synthesis, information retrieval, and/or text classification. This deep semantic understanding enables the embodiment of the invention to grasp the nuances, context, and potential subtleties within the user's inquiry, transcending traditional information retrieval systems.

To enrich this step further, an embodiment of the invention adjusts machine learning algorithms that adapt over time, refining its comprehension abilities by analyzing vast datasets of previous interactions (improvement in the content saved in the database, 203). Consequently, this embodiment of the invention becomes increasingly proficient at understanding user intent, irrespective of variations in language, tone, or context as the outcome of potential improvements made by the agent (602).

Upon receiving the user query, the system initiates an evaluation process that involves checking the knowledge repository for relevant information (102). If the system identifies a potential match, it generates a confidence score (301) that indicates the likelihood of the response being accurate (104). As the outcome of the confidence score the data processing routines are being developed to improve the dataset.

The system assesses the query against the existing knowledge base. If a response can be generated with high confidence, the system delivers this response to the user. If the confidence score is low, or if the system lacks the information needed to respond adequately, it triggers an agent notification (106).

When an agent notification is triggered (106) either by the mobile application (401) or via browser application (501), a summary of the user's query, along with the system's analysis, is sent to a select group of agents. Agents can review the query and provide additional context or information, which the system integrates into its knowledge repository.

Agents can also engage directly with the user through the system, providing real-time assistance if the situation requires. The agent's input is captured and analyzed by the machine learning module to enhance the system's future performance.

When the system finds itself lacking the necessary information or confidence (301) to respond to the user's query, it initiates the agent notification mechanism, which interfaces with a mobile application (401). The notification may be based on the urgency of the action.

The notification dispatched to a select group of agents includes a detailed exposition of the user's question, ensuring that agents receive summarized information about the communication between the system and the user.

Further, the agent, upon receiving notifications, can access the mobile application, and provide feedback directly to this embodiment of the invention. This phase encourages agents to contribute not only factual information but also context, explanations, and considerations that might be not disclosed or omitted by automated algorithms. The agent can attach references, documents, and even multimedia content to enrich the knowledge transfer from the agent to the system that further supports the process of the machine learning that will be further used in automatic responses for future conversations.

To ensure the quality and accuracy of agent contributions, the embodiment of the invention implements a verification system that relies on peer review and user feedback. Other agents may assess by rating, comment, adjust or withdraw learning samples that shall further support the learning process of the system.

To provide improved accuracy of responses, the embodiment of the invention uses sentiment analysis based on natural language processing, query matching and exact word matching to classify the reaction of the user and further adjust the tone and approach of the generated response. Conducting sentiment analysis on user queries involves evaluating the emotional tone and intent behind a user's input to better understand their satisfaction level and overall experience. By applying sentiment detection techniques, the system can classify queries as positive, negative, or neutral, and adjust the response generation process accordingly. For instance, a negative sentiment might improve response adequacy.

The system is designed to scale across various platforms and integrate with external databases and applications through the API. This ensures that the system can be adapted for use in different industries and environments, from customer service to technical support.

The knowledge repository is regularly updated, and data is managed through a combination of virtual and physical storage solutions, ensuring both accessibility and security. The embodiment of the invention further includes the hierarchical storage tiers that refer to a multi-layered approach to data storage, where information is organized and managed across different levels of storage based on factors such as frequency of access, importance, and performance requirements. In a typical hierarchical storage system, frequently accessed data is stored in faster, more expensive storage media such as solid-state drives or cloud environment that is always available (702), while less frequently accessed data is moved to slower, more cost-effective storage options depending on their character and volume (703). This tiered structure optimizes system performance and cost efficiency by ensuring that critical data is readily accessible while less critical data is stored in a manner that conserves resources. The system automatically manages the movement of data between tiers based on predefined rules, usage patterns, or real-time demand, thereby maintaining a balance between speed, storage capacity, and cost. It further enables optimal learning process from the feedback provided by the agent.

An embodiment of the presently disclosed invention is directed to a method, the subject matter of which further refers to the steps that enable the user to use the presently disclosed invention to enhance knowledge-based interactions through the integration of automated processing techniques and real-time expert input. The instant method step comprises at least the following method steps:
User interacts with the system by entering the chat widget and asking a question (101) that is received by the system. Then the system initially analyzes the query (102). After initial assessment, and if there is no possibility to generate a response based on the current state of knowledge, the question is directed to the agent to formulate a response template (106).
The system analyzes the question asked by the user with the techniques such as natural language processing, predefined conditions, matching systems or a plurality of other forms of response assignment. The main functionality is based on a search, matching and response generating ability which is supported by entities—e.g., subclasses of responses and qualifiers—and is based on the NLP mechanism (302) or equivalent of such a mechanism as query marching (303) or exact word matching (304). Furthermore, the system may prepare a set of data for the future assessment of large language models that are used in the embodiment of the invention to analyze language context.
Knowledge evaluation includes an important step of checking if there is potentially a matching response, including the stored knowledge to formulate the response or if such a response may be achieved after further quick clarification with the user. Such knowledge evaluation includes two important constituent elements:
a. Validation of the currently existing scenarios applicable to a particular question wherein such validation may extend beyond typical data matching;
b. Request for improvement of the currently existing scenarios that may happen in the form of the Agent (106) entering the response to the learning system (201) where the automated response system formulates the response (104) and delivers the response to the user (105) and at the same time learns from the provided sample (202) for future scenarios that may include a similar pattern of questions through the collection of answers and further processing performed by the database (203). Wherein the response is not exactly what the agent included in the system but rather formulated based on the response of the agent to fit contextual to the communication in the most efficient way.
If there is a reason for which the agent resigned from the inclusion of the response to the learning system where the automated response system may deliver it, the agent is enabled with the option to enter a chat conversation (201) with the user and answer directly via chat widget in the real-time (105). Importantly, samples provided by the agent directly by the chat widget may be further used in the learning process upon individual selection as well, which shall further adjust entries in the database (203).

Furthermore, the embodiment of the invention includes the broader implementation of the scenario-based sequence. The mechanism behind the system and method steps may not only match the response to the scenario element but also assign the particular response from a unit of knowledge based on the logical sequence of the inclusion of information (103). For example, if the entry in the database states that “we have offices in the US” equals “false” then if the end-user asks “Do you have offices in San Francisco” the system is fully capable to answer “no” because based on the broader context delivered to the knowledge unit it is possible to create a logical answer based on the available data set.

Having described some aspects of the present disclosure in detail, it will be apparent that further modifications and variations are possible without departing from the scope of the disclosure. All matter contained in the above description and shown in the accompanying drawings shall be interpreted as illustrative and not in a limiting sense.

What is claimed:

1. A system for knowledge-based interaction, comprising:
a user interface configured to receive user queries through multiple communication channels, the user interface comprising text-based and voice command interfaces and input elements configured to process text, audio and multimedia;
a processing engine configured to analyze user queries using natural language processing, keyword matching, and pattern recognition techniques, the processing engine comprising modules configured to parse, perform syntax analysis and perform semantic interpretation;
a confidence scoring module arranged within the processing engine, the confidence scoring module configured to generate a confidence score representing certainty in delivering answers, the confidence scoring module comprising data processing routines for evaluating the reliability of the generated responses;
a knowledge repository comprising virtual and physical databases, the knowledge repository configured to store and retrieve information relevant to user queries comprising indexed data structures;
an agent interface configured to communicate with an agent and enable the agent to modify or enhance system-generated responses and interact directly with the user in real-time, the agent interface comprising notification systems, input fields, and communication tools; and
an API framework configured to enable integration with external platforms and databases, facilitating data exchange and system interoperability, the API framework comprising standardized communication protocols, authentication mechanisms and data formatting standards; and
wherein modifications made by the agent are configured to be automatically incorporated into the processing engine so as to refine future answers' accuracy; and
wherein the processing engine is further configured to continuously update and refine answer generation processes based on data from user interactions and agent inputs, the processing engine further comprising training datasets, model adjustment routines and feedback loops.

2. The system of claim 1, wherein the user interface is further configured to support different forms of communication including text and voice-based input comprising components for processing and managing generated responses in real-time.

3. The system of claim 1, wherein:
the knowledge repository is structured to organize data based on frequency of access, context and relevance, and
the knowledge repository further comprises hierarchical storage tiers and caching mechanisms configured to facilitate quick retrieval of pertinent information.

4. The system of claim 1, wherein the processing engine includes a query classification that categorizes user queries by topic and complexity before analysis, the processing engine comprising classification tools, priority assessment mechanisms and query routing processes, and the processing engine configured to communicate with the agent based on the assessment.

5. The system of claim 1, wherein the agent interface includes a mobile application configured to enable agents to receive notifications, review summaries of user queries, and to provide input or engage in live communication with the user, the mobile application comprising real-time data synchronization and user interface elements for seamless interaction.

6. The system of claim 1, further comprising a sentiment analysis module configured to evaluate the tone and sentiment of user queries comprising data evaluation techniques that adjust the response generation process based on detected sentiment.

7. The system of claim 1, wherein the machine learning module is further configured to identify patterns in user queries and agent responses that enable the system to autonomously update the knowledge repository, the machine learning module comprising data pattern recognition processes and adaptive learning frameworks.

8. The system of claim 1, wherein the confidence scoring module is configured to be dynamically adjustable based on the complexity of the user query and the context of previous interactions, the confidence scoring module comprising response assessment processes that create confidence thresholds to specific query parameters.

9. The system of claim 1, wherein the API framework is further configured to support bi-directional communication with external systems that enable real-time updates to the knowledge repository, the API framework comprising data exchange mechanisms and integration protocols.

10. A method for enriching knowledge-based via interaction with an agent to improve an answer, the method comprising the steps of:
receiving a user query by a processing engine through a user interface;
analyzing the user query using natural language processing and pattern recognition techniques;
generating a confidence score based on the analysis of the query;
retrieving a response from a knowledge repository if the confidence score exceeds a predetermined threshold;
triggering an agent notification if the confidence score is below the threshold or if additional information is required;
enabling an agent to modify or enhance system-generated responses, interact directly with the user, and incorporate modifications into the system's machine-learning module; and
continuously updating the system's response generation processes based on data from user interactions and agent inputs.

11. The method of claim 10, further comprising the steps of:
utilizing a mobile application for agents to receive notifications, review user queries, and provide input or engage in live communication with the user.

12. The method of claim 10, wherein the knowledge repository comprises both virtual and physical databases, and the system is configured to optimize data retrieval based on the query's complexity, the knowledge repository comprising data indexing and retrieval processes configured to prioritize relevance and speed.

13. The method of claim 10, further comprising the steps of:
applying a dynamic threshold to the confidence score based on the complexity of the query, wherein simpler queries require a lower threshold and more complex queries require a higher threshold, and
applying processes that adjust response criteria dynamically.

14. The method of claim 10, further comprising the steps of:
implementing a peer review system where agent inputs are evaluated by other agents to ensure accuracy and relevance before being integrated into the knowledge repository, the peer review system comprising feedback loops and validation checks configured to enable and to maintain response quality;
conducting sentiment analysis on user queries to gauge user satisfaction and adjust the response generation process, accordingly, the sentiment analysis comprising sentiment detection techniques and response creating processes.

15. The method of claim 10, wherein:
the agent notification further comprises a detailed summary of the user's query and the preliminary analysis thereby enabling the agent to assess and provide the input, and
the agent notification further comprises real-time data processing and delivery mechanisms.

16. The method of claim 10, further comprising the steps of automatic updating of the knowledge repository with new data and insights derived from agent interactions and user feedback comprising data integration processes and continuous learning frameworks.

17. The method of claim 10, further comprising the steps of securing user interactions by encrypting data transmissions between the user interface, agent interface, and knowledge repository comprising encryption protocols and secure data handling techniques.

18. The method of claim 10, further comprising the steps of configuring the system to integrate with external platforms through an API framework, enabling real-time updates to the knowledge repository based on external data sources, comprising integration processes and data synchronization techniques.
